(19) United States
(12) Patent Application Publication
(10) Pub. No.: US 2016/0333705 A1
(43) Pub. Date: Nov. 17, 2016

(54) COMBINATION OF BLADE TIP CLADDING AND EROSION-RESISTANT LAYER AND METHOD FOR THE PRODUCTION THEREOF

(71) Applicant: MTU Aero Engines AG, Munich (DE)

(72) Inventors: Thomas UIHLEIN, Dachau (DE); Josef LINSKA, Grafing (DE); Ralf STOLLE, Wolfratshausen (DE)

(21) Appl. No.: 15/149,368

(22) Filed: May 9, 2016

(30) Foreign Application Priority Data
May 12, 2015 (DE) 102015208781.6

(51) Int. Cl. F01D 5/28

(52) U.S. Cl. CPC F01D 5/288; F05D 2230/10; F05D 2230/313; F05D 2300/16; F05D 2300/6032; F05D 2300/2282; F05D 2240/307; F05D 2240/55; F05D 2220/32

(57) ABSTRACT

A method for producing a blade for a turbomachine, the blade having a blade tip cladding on its blade tip and an erosion-resistant layer at least on its blade airfoil, wherein firstly a blade tip cladding is applied on the blade tip, subsequently a poorly adhering sublayer is deposited on the blade tip cladding, and then the erosion-resistant layer is produced on the poorly adhering sublayer and the blade airfoil, the poorly adhering sublayer being removed again together with the erosion-resistant layer following completion of the erosion-resistant layer. The invention also relates to a blade for a turbomachine, the blade having a blade tip cladding on its blade tip and an erosion-resistant layer at least on its blade airfoil. The blade tip cladding comprises a metal matrix with incorporated hard material particles and an oxide layer arranged on the metal matrix.

### CROSS-REFERENCE TO RELATED APPLICATIONS

The present application claims priority under 35 U.S.C. § 119 of German Patent Application No. 102015208781.6, filed May 12, 2015, the entire disclosure of which is expressly incorporated by reference herein.

### BACKGROUND OF THE INVENTION

1. Field of the Invention

The present invention relates to a method for producing a blade for a turbomachine, the blade having a blade tip cladding on its blade tip and an erosion-resistant layer at least on its blade airfoil. The present invention moreover relates to a corresponding blade for a turbomachine, such as for example a static gas turbine or an aero engine.

2. Discussion of Background information

Turbomachines, such as static gas turbines or aero engines, have inter alia a multiplicity of blades arranged rotatably on a rotor in order either to compress the fluid flowing through the turbomachine or to be driven in rotation by the fluid.

In order to minimize the flow losses between the rotating blades and a surrounding flow duct boundary, the gap between the blades and the flow duct boundary has to be as small as possible, such that as little fluid as possible can flow through the gap between the flow duct boundary and the blades.

For this reason, to provide a seal between the blade tips and the flow duct boundary, known turbomachines are provided with what are termed labyrinth seals, in which the blade tips move in a groove which forms, during operation of the turbomachine, in a sealing material at the flow duct boundary through corresponding cutting-in of the blade tips. Accordingly, it is also known to provide what are termed blade tip claddings at the blade tips, these blade tip claddings comprising hard material particles incorporated in a metal matrix in order to cut the groove for the labyrinth seal into the opposing sealing material of the flow duct boundary by means of the hard material particles and to protect the blade tip against wear.

In addition, blades of turbomachines additionally comprise protective coatings, such as erosion-resistant layers, at the blade airfoil, in order to likewise protect the blade material against wear, for example caused by erosion, in the region of the blade airfoil.

Accordingly, it is necessary to arrange different coatings alongside one another on a blade for a turbomachine, such as for example a tip cladding at the blade tips and an erosion-resistant coating at the blade airfoil, it being necessary to avoid a situation, however, in which one of the coatings and in particular the blade tip cladding is covered by the other coating, specifically the erosion-resistant layer, since the covered layer, that is e.g. the blade tip cladding, can then no longer perform its function in the desired way. Instead, failure of the cutting function of the blade tip cladding can lead to serious damage to the blade as a result of excessively high thermal and mechanical loads.

Accordingly, the individual layers have to be applied in succession in a suitable manner without the layers being undesirably covered.

DE 10 2010 049 398 A1, the entire disclosure of which is incorporated by reference herein, discloses a wear-resistant and oxidation-resistant turbine blade which comprises an oxidation-resistant, metallic layer, in particular an MCrAlY layer, M being a metal, in particular nickel, cobalt or a combination thereof, and which can additionally comprise a ceramic thermal barrier layer. In addition to this oxidation-resistant protective layer, a protective layer of abrasive material and binding material applied by means of laser build-up welding is provided on the blade tip. Firstly, the oxidation-resistant protective layer in the form of the MCrAlY layer is applied to the blade over its entire surface area. The MCrAlY layer is mechanically removed again in the region of the blade tip, and then the wear-resistant protective layer is applied at the blade tip in the region of the blade tip by means of laser build-up welding.

This method is very complex and susceptible to errors, since the protective layer may also be damaged further during removal of the oxidation-resistant protective layer in the region of the blade tip. Moreover, the laser build-up welding can also lead to damage to or covering of the oxidation-resistant layer.

It would therefore be advantageous to have available a method for producing a blade for a turbomachine in which at least two different coatings can be arranged on the blade in a simple and reliable manner without the function and quality of the individual coatings being mutually impaired. In particular, it would be advantageous to be able to apply a blade tip cladding in addition to an erosion-resistant layer in an efficient manner for a blade of a turbomachine, wherein the erosion-resistant layer in particular does not bring about covering of the blade tip cladding and therefore an impairment in the operation of the blade tip cladding. In addition, it would be advantageous to he able to provide a corresponding blade for a turbomachine, such as a static gas turbine or an aero engine.

### SUMMARY OF THE INVENTION

The present invention provides a method for producing a blade for a turbomachine, which blade comprises a blade tip cladding on its blade tip and an erosion-resistant layer at least on its blade airfoil. The method comprises firstly applying a blade tip cladding on the blade tip, subsequently depositing on the blade tip cladding a poorly adhering sublayer, and thereafter forming the erosion-resistant layer on the poorly adhering sublayer and the blade airfoil. The poorly adhering sublayer is removed together with the erosion-resistant layer following completion of the erosion-resistant layer.

In one aspect of the method, the poorly adhering sublayer may have an adhesion which is selected to be sufficiently high so that the poorly adhering sublayer is not detached before or during deposition of the erosion-resistant layer, and sufficiently low to allow for simple detachment of the poorly adhering sublayer.

In another aspect of the method, a metal layer may be deposited on an oxide layer produced beforehand on the blade tip cladding as the poorly adhering sublayer. For example, the oxide layer may be produced electrolytically by anodic oxidation of the blade tip cladding and/or the poorly adhering sublayer may be produced by electrodeposition of a metal such as, e.g., nickel.

In yet another aspect of the method, the blade tip cladding may be produced by electrodeposition of a nickel matrix with incorporated hard material particles, which particles may comprise, for example, particles of boron nitride.

In a still further aspect of the method, the erosion-resistant layer may be deposited by physical vapor deposition such as, e.g., evaporation coating.

In another aspect of the method, the blade may be cleaned before the deposition of the erosion-resistant layer, for example by sputtering.

In another aspect of the method, the erosion-resistant layer deposited on the blade tip cladding may be mechanically removed with the poorly adhering sublayer after the deposition of the erosion-resistant layer. For example, the erosion-resistant layer may be mechanically removed with the poorly adhering sublayer during the cleaning of the blade.

The present invention also provides a blade for a turbomachine and in particular a blade produced by the method of the present invention as set forth above (including the various aspects thereof). The blade comprises a blade tip cladding on its blade tip and an erosion-resistant layer at least on its blade airfoil. The blade tip cladding comprises a metal matrix with incorporated hard material particles. An oxide layer is arranged on the metal matrix.

In one aspect of the blade, the oxide layer may have a thickness of not more than 0.1 μm, e.g., not more than 50 nm, or not more than 10 nm.

In another aspect of the blade, the blade tip cladding may be surrounded by the erosion-resistant layer and/or may be embedded therein.

In the case of a blade, the invention proposes firstly applying a first coating, in particular a blade tip cladding, on the blade tip, and subsequently depositing a poorly adhering sublayer on the first coating or the applied blade tip cladding, said sublayer serving at a later point in time as a predetermined breaking point. According to the method according to the invention, a second coating, specifically in the present case the erosion-resistant layer, is thus concomitantly applied to the first coating or blade tip cladding with the poorly adhering sublayer when the second layer, that is to say the erosion-resistant layer, is applied in the regions of the blade intended therefor, i.e. for example on the blade airfoil, such that it is possible for the blade to be coated over its entire surface area with the second coating, i.e. the erosion-resistant layer, whereas the first coating or blade tip cladding is deposited only in a locally limited manner, that is to say on the blade tip. Once the erosion-resistant layer (second coating) has then been applied to the entire surface area of the regions in which the erosion-resistant layer is to be provided and to the region of the blade tip cladding (first coating) with the poorly adhering sublayer, the erosion-resistant layer (second coating) is removed again in the region of the blade tip cladding (first coating), the poorly adhering sublayer making simple removal of the erosion-resistant layer (second coating) possible.

Accordingly, “poorly adhering” can be understood to mean an adhesion which is selected in such a way that it is sufficiently high so that the poorly adhering sublayer is not detached before or during the deposition of the erosion-resistant layer, but at the same time is as low as possible in order to bring about simple detachment of the poorly adhering sublayer with the erosion-resistant layer arranged thereon.

One possible way of realizing a poorly adhering sublayer comprises firstly producing a thin oxide layer on the blade tip cladding and depositing a metal layer on said oxide layer, such that the metal layer constitutes a poorly adhering sublayer having weak adhesion on the oxide layer.

A corresponding oxide layer can be produced electrolytically by anodic oxidation of the blade tip cladding and/or the poorly adhering sublayer in the form of a metal layer can be produced by electrodeposition of metal.

This is particularly advantageous if the blade tip cladding is formed by a metal matrix provided with incorporated hard material particles. By way of example, a blade tip cladding of this type can consist of a nickel matrix with incorporated particles of boron nitride, in particular cubic boron nitride. A blade tip cladding of this type can be produced easily by electrodeposition of a nickel matrix with incorporated hard material particles, it then being possible for an oxide layer to be produced by anodic oxidation of the blade tip cladding in a simple manner by polarity reversal in the electrolytic process. To this end, the polarity of the blade which is connected as cathode during the electrodeposition merely has to be reversed to the anode, such that the anodic oxidation in particular of the nickel matrix of the blade tip cladding can be effected. Accordingly, it is then possible in a further step for nickel to be electrodeposited in turn by renewed reversal of the polarity of the blade, such that a metallic layer or nickel layer is produced on the oxide layer produced by the anodic oxidation, but adheres poorly on the oxide layer.

According to the invention, the erosion-resistant layer is deposited on the thus prepared blade tip cladding in addition to those regions in which the erosion-resistant layer is actually to be provided. The deposition can be effected by physical vapor deposition, in particular evaporation coating, and thus requires no local delimitation of the deposition.

The blade can be cleaned, for example by sputtering, before the deposition of the erosion-resistant layer, the already present blade tip cladding with the poorly adhering sublayer, for example in the form of the nickel layer deposited on the oxide layer, being formed in such a way that the poorly adhering sublayer is not detached during the cleaning of the blade.

The erosion-resistant layer can be detached from the blade tip cladding following completion of the erosion-resistant layer by simple machining, for example during the cleaning and/or smoothing of the applied erosion-resistant layer by grinding or the like. The poorly adhering sublayer and the predetermined breaking point thereby predefined in the layer assembly in the region of the blade tip cladding result there in simple detachment of the erosion-resistant layer with the poorly adhering sublayer in the form of a metal layer.

The erosion-resistant layer can be detached completely or partially even during first operation of the blade, since the erosion-resistant layer is removed in the region of the blade tip cladding even under minor mechanical loading.

Accordingly, a blade for a turbomachine having a blade tip cladding and an erosion-resistant layer, in which the blade tip cladding comprises a metal matrix with incorporated hard material particles, comprises an oxide layer arranged on the metal matrix of the blade tip cladding.

The corresponding oxide layer may have a very thin form and in particular can have a thickness in the nanometer range, i.e. for example a thickness of less than or equal to 0.1 μm, preferably less than or equal to 50 nm and in particular less than or equal to 10 nm. Such a thin oxide layer can be removed quickly and easily during operation, when the blade tip rubs against the opposing sealing material, and therefore the blade tip cladding can perform its function to the full extent.

### BRIEF DESCRIPTION OF THE DRAWINGS

The accompanying drawings show, in a purely schematic manner, in

FIG. 1 a perspective view of a blade as can be used in turbomachines, and in

FIG. 2 in sub-figures a) to f) part of a turbine blade after the various method steps.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

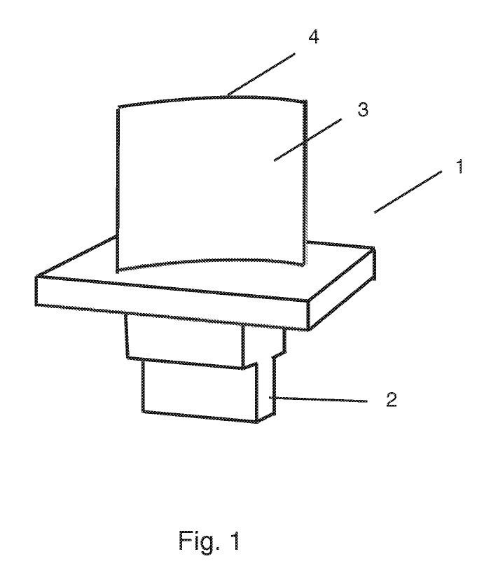

FIG. 1 shows, in a purely schematic manner, a perspective view of a blade as can be used in a turbomachine, such as for example a static gas turbine or an aero engine. The blade 1 has a blade root 2 which can be inserted into a disk that rotates with a shaft of the turbomachine. The blade 1 also has a blade airfoil 3, which is arranged in the flow duct of the turbomachine and either compresses the fluid flowing through the turbomachine or is driven by the fluid flowing past. What is termed the blade tip 4 is located at the radially outer end of the blade 1, said blade tip bearing as tightly as possible against a surrounding flow duct housing or even cutting into the latter to avoid flow losses. For this purpose, a blade tip cladding, which also has a cutting function, is provided on the blade tip 4, such that the blade tip 4 can cut into a surrounding flow duct housing or sealing material arranged thereon. By way of example, the blade tip cladding can be formed by a coating comprising a nickel matrix with incorporated cubic boron nitride particles.

For protecting the blade 1, the blade airfoil 3 likewise has a coating, specifically an erosion-resistant coating, which is intended to protect the material of the blade 1 against wear caused by erosion. An erosion-resistant coating of this type can consist of what is termed a multi-layer layer or multi-ply layer, which can consist of a multiplicity of hard and soft layers deposited in alternation, in particular ceramic layers and metal layers.

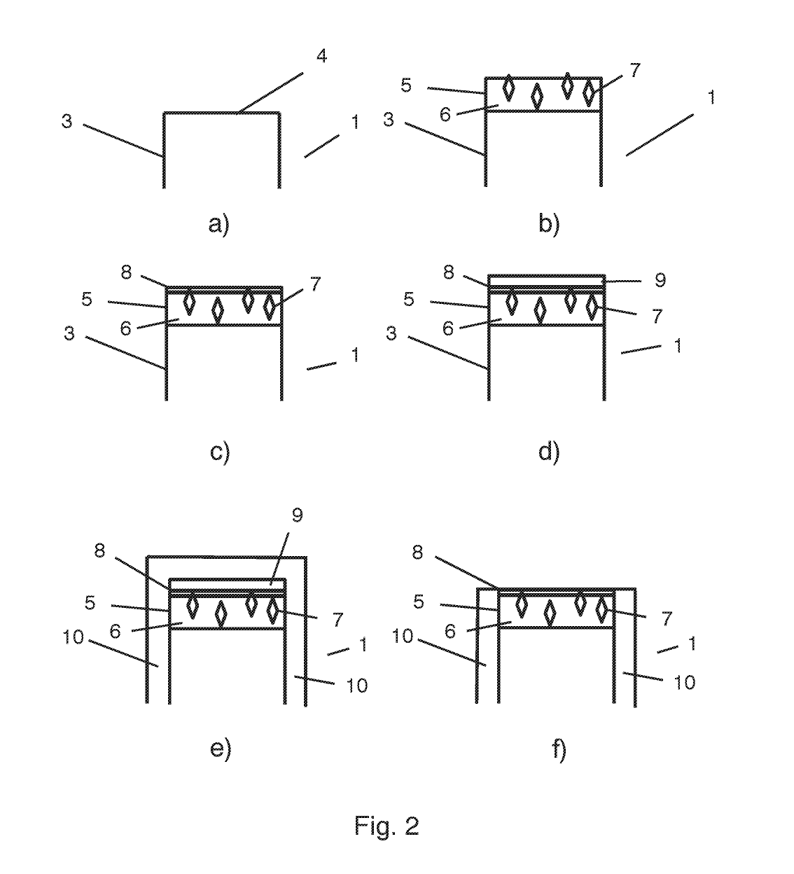

FIG. 2 shows, in sub-figures a) to f), the various stages of the production of a blade having a blade tip cladding on the blade tip 4 and an erosion-resistant coating on the blade airfoil 3. Sub-figure a) of FIG. 2 shows part of a blade 1 with the blade airfoil 3 and the blade tip 4.

As shown in sub-figure b) of FIG. 2, a blade tip cladding 5 consisting of a nickel matrix and particles 7 of cubic boron nitride incorporated therein is applied to the blade tip 4. The blade tip cladding 5 is applied by electrodeposition of the nickel matrix 6, in which the cubic boron nitride particles are incorporated.

Once the blade tip cladding 5 has been completed, it is the case that, instead of the cathodic deposition of the nickel, the electrolysis is modified in such a way that the blade 1 is connected as anode, such that the nickel matrix 6 is oxidized anodically and a thin oxide layer 8 forms on the nickel matrix 6, this oxide layer being visible in sub-figure c) of FIG. 2. The thickness of the deposited oxide layer lies in the nanometer range, and may be in particular less than or equal to 0.1 μm, less than or equal to 100 nm or less than or equal to 10 nm.

Once the electrolysis has been carried out in the electrolysis bath for a sufficient period of time to produce an oxide layer 8 of sufficient thickness, the blade 1 is connected as cathode again, giving rise again to electrodeposition of nickel. A further nickel layer 9 is thus deposited above the oxide layer 8, but has a poor adhesion on the oxide layer 8. In a manner similar to the thickness of the oxide layer, the thickness of the nickel layer 9 may be very small, and may likewise lie in the nanometer range, for example less than or equal to 0.1 μm.

The thus prepared blade 1, which is visible in sub-figure d) of FIG. 2, is then prepared for the application of the erosion-resistant layer 10, this meaning that the cover (not shown) on the blade airfoil 3 which serves to ensure that no electrodeposition and/or anodic oxidation can occur outside the region of the blade tip 4 is removed, and the entire blade 1 or at least those regions in which the erosion-resistant layer is to be provided are prepared for the deposition of the erosion-resistant layer by cleaning. The cleaning can he effected, for example, by sputtering. The poorly adhering nickel layer 9 on the thin oxide layer 8 must not be removed completely by the cleaning sputtering before the application of the erosion-resistant layer 10. Accordingly, the nickel layer 9 has to be sufficiently thick to withstand the cleaning sputtering before the application of the erosion-resistant layer.

After the cleaning, the erosion-resistant layer 10 can then be deposited by physical vapor deposition (PVD), to be precise in particular by evaporation coating of the corresponding partial layers of the multi-layer erosion-resistant layer. In the process, the blade 1 is coated over its entire surface area both on the blade airfoil 3 and on the blade tip 4 above the blade tip cladding 5, to be precise on the nickel layer 9 (see see sub-figure e) of FIG. 2).

In order to expose the blade tip cladding 5 again and in order to provide the hard material particles, such as the cubic boron nitride, during operation of the blade for cutting into an opposing sealing material, the erosion-resistant layer 10 is removed again in the region of the blade tip cladding 5, it being possible for the nickel layer 9 and the erosion-resistant layer 10 to be readily removed in a simple manner in the region of the blade tip cladding 5 as a result of the poor adhesion of the nickel layer 9 on the oxide layer 8. The removal of the erosion-resistant layer 10 above the blade tip cladding 5 can be effected by simple mechanical methods, such as grinding or the like, and can be effected in particular already in a cleaning step which can be carried out after the deposition of the erosion-resistant layer 10, since the poor adhesion of the nickel layer 9 on the oxide layer 8 means that the erosion-resistant layer 10 can be readily removed in the region of the blade tip cladding 5.

The situation after the removal of the erosion-resistant layer 10 in the region of the blade tip cladding 5 is shown in sub-figure f) of FIG. 2. As can he seen, all that is located above the nickel matrix 6 is an oxide layer 8, which can easily be removed when the blade tip cladding rubs against an opposing sealing material, such that the particles of cubic boron nitride incorporated in the nickel matrix 6 can easily perform their cutting function.

The blade tip cladding 5 is embedded into the adjacent erosion-resistant layer 10 and is surrounded by the latter, without the grinding surface of the blade tip cladding 5 which comes into contact with an opposing sealing material being covered.

Although the present invention has been described clearly with reference to the exemplary embodiments shown, the invention is not limited to these exemplary embodiments, but instead modifications are possible in such a manner that individual features can be omitted or differing combinations of features can be implemented, as long as the scope of protection of the accompanying claims is not departed from.

What is claimed is:

1. A method for producing a blade for a turbomachine, which blade comprises a blade tip cladding on its blade tip and an erosion-resistant layer at least on its blade airfoil, wherein the method comprises firstly applying a blade tip cladding on the blade tip, subsequently depositing on the blade tip cladding a poorly adhering sublayer, and thereafter forming the erosion-resistant layer on the poorly adhering sublayer and the blade airfoil, the poorly adhering sublayer being removed together with the erosion-resistant layer following completion of the erosion-resistant layer.

2. The method of claim 1, wherein the poorly adhering sublayer has an adhesion which is selected to be sufficiently high so that the poorly adhering sublayer is not detached before or during deposition of the erosion-resistant layer, and sufficiently low to allow for simple detachment of the poorly adhering sublayer.

3. The method of claim 1, wherein, as the poorly adhering sublayer, a metal layer is deposited on an oxide layer produced beforehand on the blade tip cladding.

4. The method of claim 3, wherein the oxide layer is produced electrolytically by anodic oxidation of the blade tip cladding.

5. The method of claim 3, wherein the poorly adhering sublayer is produced by electrodeposition of metal.

6. The method of claim 5, wherein the metal comprises nickel.

7. The method of claim 4, wherein the poorly adhering sublayer is produced by electrodeposition of metal.

8. The method of claim 1, wherein the blade tip cladding is produced by electrodeposition of a nickel matrix with incorporated hard material particles.

9. The method of claim 8, wherein the hard particles comprise particles of boron nitride.

10. The method of claim 1, wherein the erosion-resistant layer is deposited by physical vapor deposition.

11. The method of claim 10, wherein the erosion-resistant layer is deposited by evaporation coating.

12. The method of claim 1, wherein the blade is cleaned before the deposition of the erosion-resistant layer.

13. The method of claim 12, wherein the blade is cleaned by sputtering.

14. The method of claim 1, wherein the erosion-resistant layer deposited on the blade tip cladding is mechanically removed with the poorly adhering sublayer after deposition of the erosion-resistant layer.

15. The method of claim 14, wherein the erosion-resistant layer deposited on the blade tip cladding is mechanically removed with the poorly adhering sublayer during cleaning of the blade.

16. A blade for a turbomachine, wherein the blade comprises a blade tip cladding on its blade tip and an erosion-resistant layer at least on its blade airfoil, the blade tip cladding comprising a metal matrix with incorporated hard material particles and an oxide layer being arranged on the metal matrix.

17. The blade of claim 16, wherein the oxide layer has a thickness of less than or equal to 0.1 μm.

18. The blade of claim 16, wherein the oxide layer has a thickness of less than or equal to 50 nm.

19. The blade of claim 16, wherein the oxide layer has a thickness of less than or equal to 10 nm.

20. The blade of claim 16, wherein the blade tip cladding is surrounded by the erosion-resistant layer and/or is embedded therein.
